(19) United States
(12) Patent Application Publication
(10) Pub. No.: US 2025/0133550 A1
(43) Pub. Date: Apr. 24, 2025

(54) CELL WITH COMBINED NONCONTIGUOUS SPECTRUMS

(71) Applicant: QUALCOMM Incorporated, San Diego, CA (US)

(72) Inventors: Huilin XU, Temecula, CA (US); Kazuki TAKEDA, Tokyo (JP); Chao WEI, Beijing (CN); Jing LEI, San Diego, CA (US); Muhammad Sayed Khairy ABDELGHAFFAR, San Jose, CA (US); Peter GAAL, San Diego, CA (US)

(21) Appl. No.: 18/685,100

(22) PCT Filed: Oct. 6, 2021
(86) PCT No.: PCT/CN2021/122516

§ 371 Date: Feb. 20, 2024

(51) Int. Cl. H04W 72/0453; H04L 27/26; H04W 72/1263

(52) U.S. Cl. CPC H04W 72/0453; H04L 27/2666; H04W 72/1263

(57) ABSTRACT

Certain aspects of the present disclosure provide techniques for configuring for communications on noncontiguous carriers of a single cell. By combining multiple noncontiguous carriers into a single cell, broadcast overhead can be reduced and cell management (i.e., only one cell) can be simplified. For example, a network entity may transmit to a user equipment (UE) configuration information that configures the UE for communications on noncontiguous carriers of a single cell. The network entity and the UE may then communicate on the noncontiguous carriers in accordance with the configuration information.

### BACKGROUND

### Field of the Disclosure

Aspects of the present disclosure relate to wireless communications and, more particularly, to techniques for making use of noncontiguous carriers for a single cell.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Features of this disclosure provide advantages that include configuring for communications on noncontiguous carriers of a single cell.

Certain aspects of the subject matter described in this disclosure can be implemented in a method for wireless communication by a network entity (e.g., a base station (BS)). The method generally includes transmitting, to a user equipment (UE), configuration information configuring the UE for communications on noncontiguous carriers of a single cell and communicating with the UE on the noncontiguous carriers in accordance with the configuration information.

Certain aspects of the subject matter described in this disclosure can be implemented in a method for wireless communication by a first sidelink user equipment (UE). The method generally includes receiving, from a network entity, configuration information configuring the UE for communications on noncontiguous carriers of a single cell; and communicating with the network entity on the noncontiguous carriers in accordance with the configuration information.

Certain aspects of the subject matter described in this disclosure can be implemented in an apparatus for wireless communication. The apparatus generally includes at least one processor and a memory coupled to the at least one processor. The at least one processor and the memory are configured to transmit, to a user equipment (UE), configuration information configuring the UE for communications on noncontiguous carriers of a single cell and communicate with the UE on the noncontiguous carriers in accordance with the configuration information.

Certain aspects of the subject matter described in this disclosure can be implemented in an apparatus for wireless communication. The apparatus generally includes at least one processor and a memory coupled to the at least one processor. The at least one processor and the memory are configured to receive, from a network entity, configuration information configuring the UE for communications on noncontiguous carriers of a single cell; and communicate with the network entity on the noncontiguous carriers in accordance with the configuration information.

Certain aspects of the subject matter described in this disclosure can be implemented in a computer readable medium storing computer executable code thereon for wireless communication. The computer executable code generally includes code for transmitting, to a user equipment (UE), configuration information configuring the UE for communications on noncontiguous carriers of a single cell and communicating with the UE on the noncontiguous carriers in accordance with the configuration information.

Certain aspects of the subject matter described in this disclosure can be implemented in a computer readable medium storing computer executable code thereon for wireless communication. The computer executable code generally includes code for receiving, from a network entity, configuration information configuring the UE for communications on noncontiguous carriers of a single cell; and communicating with the network entity on the noncontiguous carriers in accordance with the configuration information.

While aspects are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 illustrates fragmented spectrums that may be used in a single cell, in accordance with certain aspects of the present disclosure.

FIG. 5 illustrates parameters for defining a carrier and a bandwidth part (BWP) therein, in accordance with certain aspects of the present disclosure.

FIG. 6 is a flow diagram illustrating example operations for wireless communication by a network entity, in accordance with certain aspects of the present disclosure.

FIG. 7 is a flow diagram illustrating example operations for wireless communication by a UE, in accordance with certain aspects of the present disclosure.

FIG. 8 illustrates an example cell made of two noncontiguous carriers, in accordance with certain aspects of the present disclosure.

FIG. 9 illustrates an example cell and the BWP therein, in accordance with certain aspects of the present disclosure.

FIG. 10 illustrates a communications device that may include various components configured to perform operations for the techniques disclosed herein in accordance with aspects of the present disclosure.

FIG. 11 illustrates a communications device that may include various components configured to perform operations for the techniques disclosed herein in accordance with aspects of the present disclosure.

To facilitate understanding, identical reference numerals have been used, where possible, to designate identical elements that are common to the figures.

### DETAILED DESCRIPTION

Aspects of the present disclosure provide apparatus, methods, processing systems, and computer readable mediums for configuring a UE for communications on noncontiguous carriers of a single cell. By combining multiple noncontiguous carriers into a single cell, broadcast overhead can be reduced and cell management can be simplified. For example, a network entity may transmit to a user equipment (UE) configuration information that configures the UE for communications on noncontiguous carriers of a single cell. The network entity and the UE may then communicate on the noncontiguous carriers in accordance with the configuration information.

In some systems (e.g., 5G new radio (NR) systems), a network may operate over fragmented spectrums (e.g., re-farmed from LTE). These fragmented spectrums may each have relatively narrow bandwidth. To access these spectrums for high data rate communications, the network may configure multiple cells separately on the spectrums (i.e., one cell in one carrier). The network may accordingly configure carrier aggregation to the UE. However, such multiple cells configurations may result in high resource overhead due to the transmission of broadcast information in all carriers and complicated management of multiple cells. The present disclosure provides techniques for reducing transmission overhead and simplifying cell management by combining multiple carriers into a single cell. Various configuration techniques are provided in details below.

The following description provides examples of configuring for communications on noncontiguous carriers of a single cell. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. The disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

### Example Wireless Communication Network

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave (mmW) targeting high carrier frequency, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe. NR supports beamforming and beam direction may be dynamically configured. MIMO transmissions with precoding may also be supported. MIMO configurations in the DL may support multiple transmit antennas with multi-layer DL transmissions. Multi-layer transmissions may be supported. Aggregation of multiple cells may be supported.

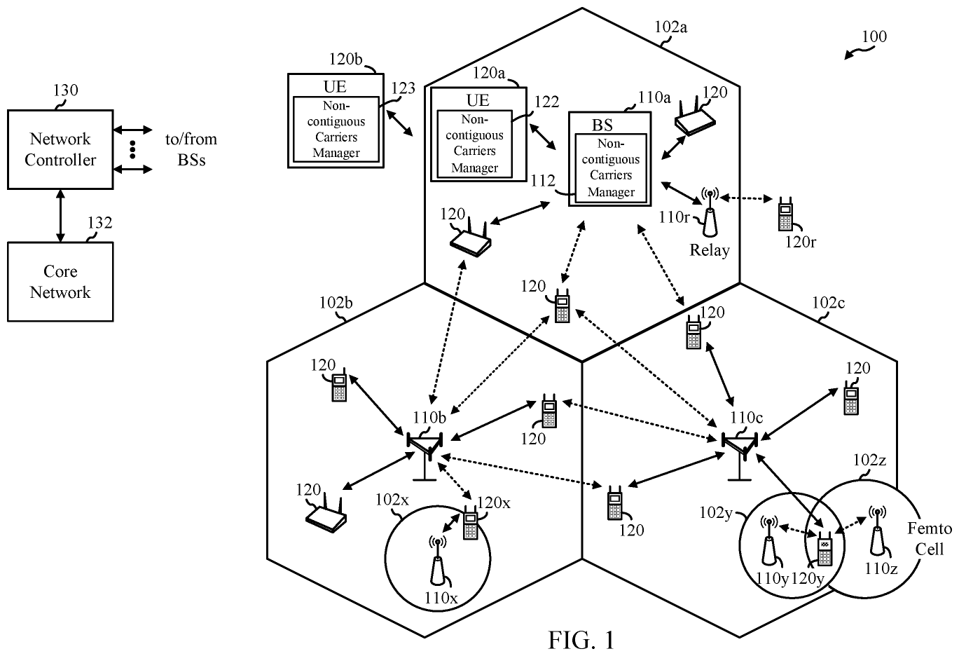

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110a-z (each also individually referred to herein as BS 110 or collectively as BSs 110) and other network entities and/or user equipments (UEs) 120a-y (each also individually referred to herein as UE 120 or collectively as UEs 120) in the wireless communication network 100 via one or more interfaces.

According to certain aspects, the BSs 110 and UEs 120 may be configured for carrier selection in an unlicensed spectrum. In some examples, the UEs 120 may be configured for sidelink communications. As shown in FIG. 1, the BS 110a includes a noncontiguous carriers manager 112 that may be configured for configuring for communications on noncontiguous carriers of a single cell, in accordance with aspects of the present disclosure. As shown in FIG. 1, the UE 120a includes noncontiguous carriers manager 122 that may be configured for configuring for communications on noncontiguous carriers of a single cell, in accordance with aspects of the present disclosure. As shown in FIG. 1, the UE 120b in sidelink communication with the UE 120a includes noncontiguous carriers manager 123 that may be configured for configuring for communications on noncontiguous carriers of a single cell in sidelink communications, in accordance with aspects of the present disclosure. For example, the UE 120b may use configuration information received at the UE 120a via sidelink in order to be configured for communicating over a single cell of multiple noncontiguous carriers.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

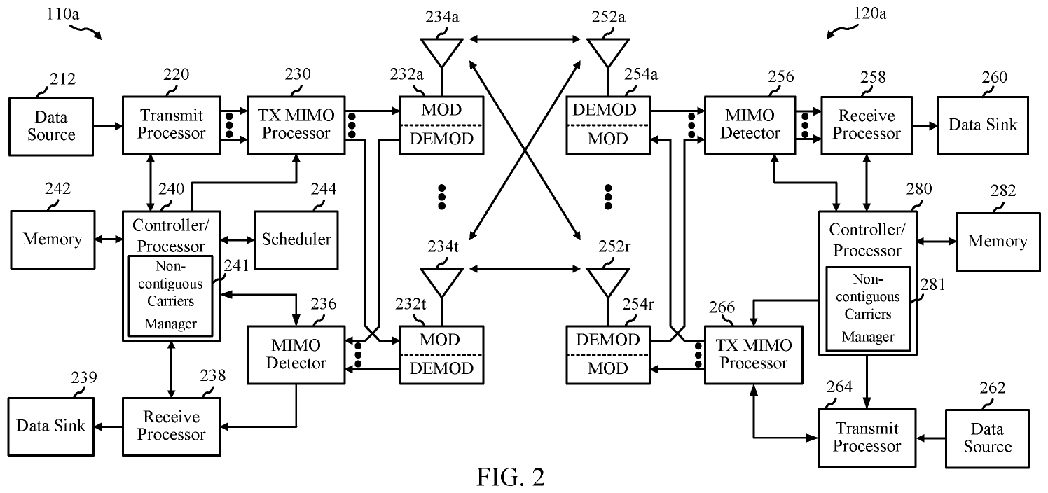

FIG. 2 illustrates example components of BS 110a and UE 120a (e.g., as shown in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators in transceivers 232a-232t may be transmitted via the antennas 234a-234t, respectively.

At the UE 120a (or similarly in the UE 120b), the antennas 252a-252r may receive the downlink signals from the BS 110a and may provide received signals to the demodulators (DEMODs) in transceivers 254a-254r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink or sidelink, at UE 120a, a transmit processor 264 may receive and process data (e.g., for the physical uplink shared channel (PUSCH) or physical sidelink shared channel (PSSCH)) from a data source 262 and control information (e.g., for the physical uplink control channel (PUCCH) or physical sidelink control channel)) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a (or to a sidelink UE 120b). At the BS 110a (or sidelink UE 120b), the uplink signals from the UE 120a may be received by the antennas 234, processed by the demodulators, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a noncontiguous carriers manager 241 that may be configured for configuring for communications on noncontiguous carriers of a single cell, according to aspects described herein. As shown in FIG. 2, the controller/processor 280 of the UE 120a has noncontiguous carriers manager 281 that may be configured for configuring for communications on noncontiguous carriers of a single cell, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

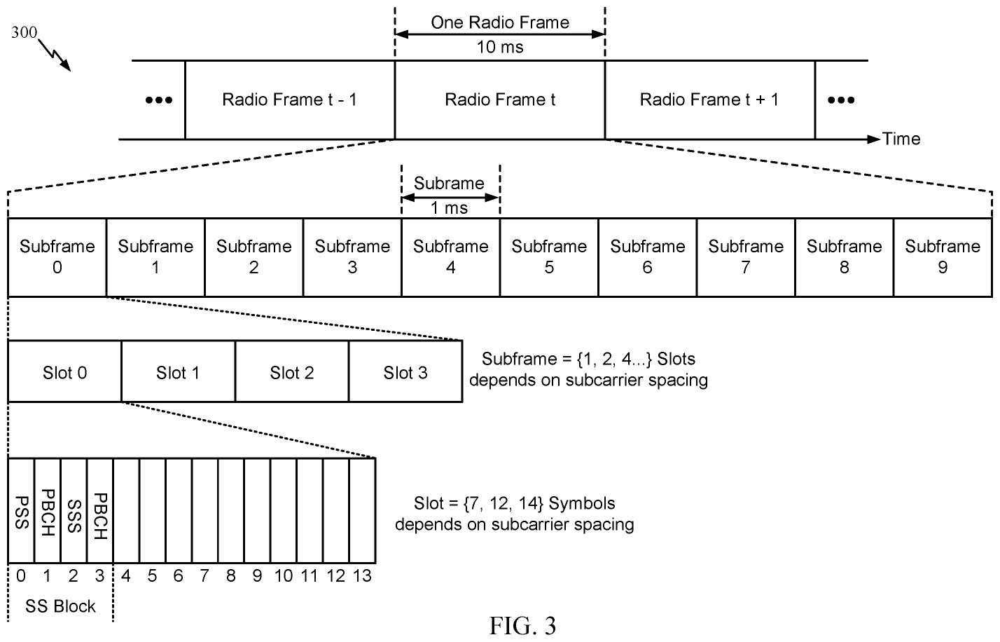

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure is a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

### Example Fragmented Spectrums and Carrier Configurations

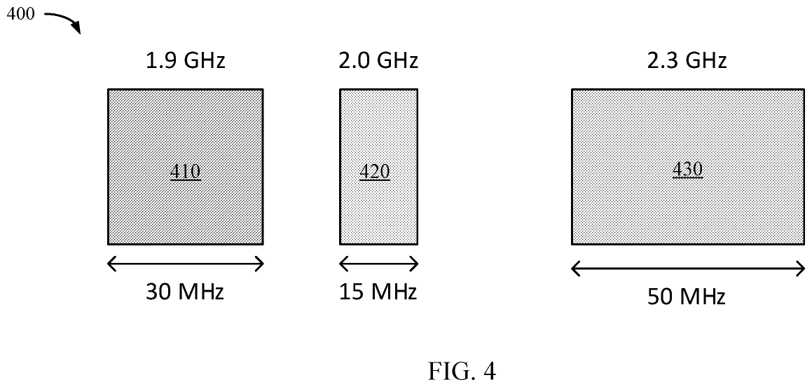

FIG. 4 illustrates fragmented spectrums 400 to be used in a cell, in accordance with certain aspects of the present disclosure. As shown, the fragmented spectrums may have different operating frequencies and bandwidths. For example, the spectrum 410 has a frequency of 1.9 GHz and a bandwidth of 30 MHz. The spectrum 420 has a frequency of 2.0 GHz and a bandwidth of 15 MHz. The spectrum 430 has a frequency of 2.3 GHZ and a bandwidth of 50 MHz. These fragmented spectrums may be re-framed from LTE. For example, LTE carriers often are narrower in bandwidth than 5G NR carrier bandwidths (e.g., up to 20 MHz for LTE and can be aggregated to 100 MHz in LTE-Advance, while 5G NR may have up to 100 MHz in FR1 or 400 MHz in FR2 and be aggregated to up to 800 MHZ).

Example Cell with Combined Noncontiguous Spectrums

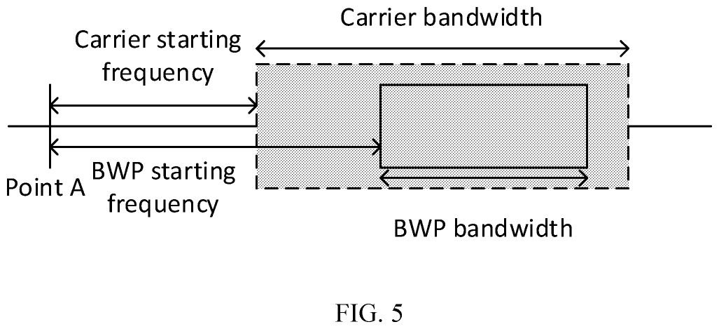

In order to access these spectrums for high data rate communications, and to avoid configuring multiple cells separately on the spectrums, the present disclosure provides techniques for configuring noncontiguous carriers in a single cell. The configurations may be based on one or more parameters illustrated in FIG. 5.

FIG. 5 illustrates parameters for defining a carrier and a bandwidth part (BWP) therein, in accordance with certain aspects of the present disclosure. As shown, a cell or a carrier of a cell may be defined in relation to a frequency reference or frequency reference point (Point A). Such reference point may usually be obtained from SIB1 based on a frequency offset to the lowest frequency of the SSB detected during an initial access or based on a configuration of the absolute frequency thereafter.

To configure a carrier, a carrier starting frequency may be configured relative to the frequency reference point. Further, the carrier is configured with a carrier bandwidth. Within the carrier, a bandwidth part (BWP) may be defined. As shown, a BWP starting frequency may also be configured relative to the frequency reference point. The BWP is also configured with a BWP bandwidth. By configuration, the entire bandwidth of the BWP is within the bandwidth of the carrier in which the UE operates. Each BWP has a single starting frequency and BWP bandwidth configuration.

Accordingly, the present disclosure provides techniques for configuring multiple non-contiguous carriers by determining and signaling various parameters in a single cell.

Aspects of the present disclosure provide apparatus, methods, processing systems, and computer readable mediums for configuring a UE for communications on noncontiguous carriers of a single cell. By combining multiple noncontiguous carriers into a single cell, broadcast overhead can be reduced and cell management can be simplified. For example, a network entity may transmit to a user equipment (UE) configuration information that configures the UE for communications on noncontiguous carriers of a single cell. The network entity and the UE may then communicate on the noncontiguous carriers in accordance with the configuration information.

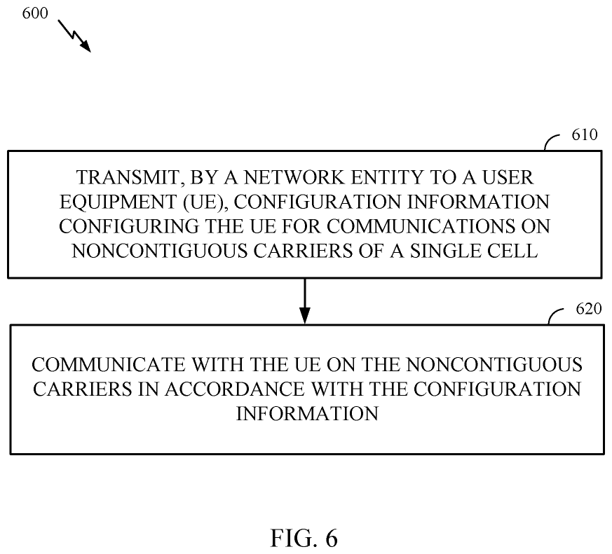

FIG. 6 is a flow diagram illustrating example operations 600 for wireless communication. For example, operations 600 may be performed, by a network entity (e.g., the BS 110a in the wireless communication network 100 of FIG. 1). The operations 600 may be implemented as software components that are executed and run on one or more processors (e.g., controller/processor 240 of FIG. 2). Further, the transmission and reception of signals by the PCS in operations 600 may be enabled, for example, by one or more antennas (e.g., antennas 234 of FIG. 2). In certain aspects, the transmission and/or reception of signals by the PCS may be implemented via a bus interface of one or more processors (e.g., controller/processor 240) obtaining and/or outputting signals.

The operations 600 begin, at 610 by transmitting, to a user equipment (UE), configuration information configuring the UE for communications on noncontiguous carriers of a single cell. At 620, the network entity communicates with the UE on the noncontiguous carriers in accordance with the configuration information.

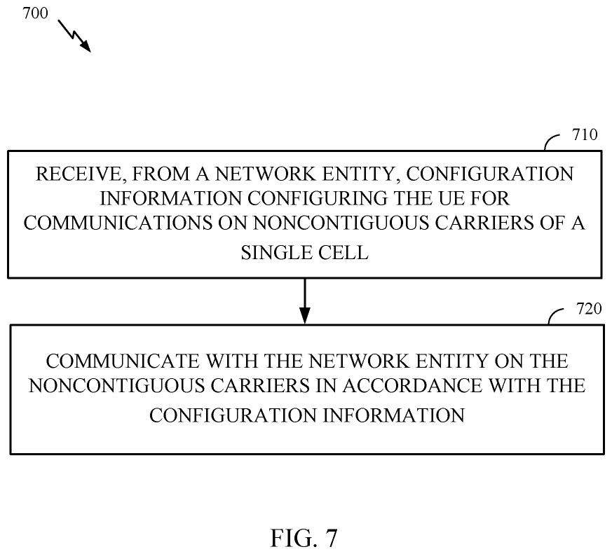

FIG. 7 is a flow diagram illustrating example operations 700 for wireless communication that may be considered complimentary to the operations 600. The operations 700 may be performed, for example, by a UE (e.g., the UE 120a in the wireless communication network 100). The operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 700 begin, at 710, by receiving capability information of the UE. At 720, the UE transmitting the configuration to the UE only if the capability information indicates the UE supports communications on noncontiguous carriers.

In certain aspects, the configuration information indicates two or more frequency reference points. Each of the two or more reference points may be associated with one of the noncontiguous carriers. As shown in FIG. 5, a carrier may be determined based on the frequency reference point, the carrier starting frequency (or frequency offset), and the carrier bandwidth. Therefore, even if one or more of the carrier starting frequency and bandwidth may stay constant, configuring two or more frequency reference points in a single cell allows for configuration of two or more carriers. For example, because the maximum frequency offset from the lowest frequency subcarrier of a carrier to a frequency reference point is 1.6 GHz in FR1 and 3.2 GHz in FR2, when in case that the noncontiguous carriers combined in the cell have a frequency span larger than the maximum frequency offset in a frequency range based on a single reference point, additional frequency reference points can be configured for the single cell.

In some cases, the frequency reference points may be separately defined for downlink and uplink. That is, at least a first one of the frequency reference points defines a carrier for uplink transmission, and at least a second one of the frequency reference points defines a carrier for downlink transmission.

In certain aspects, multiple carriers are configured for respective downlink and uplink transmissions within a cell. For each carrier, the bandwidth may be indicated based on an associated reference subcarrier spacing. For example, for each carrier of the combined carriers, the spectrum is configured based on a pair of offsetToCarrier (frequency offset to the associated frequency reference point) and carrierBandwidth based on the associated reference subcarrier spacing (subcarrierSpacing). To combine multiple carriers in downlink and uplink in a cell, multiple such pairs of offsetToCarrier and carrierBandwidth may be configured by the network entity.

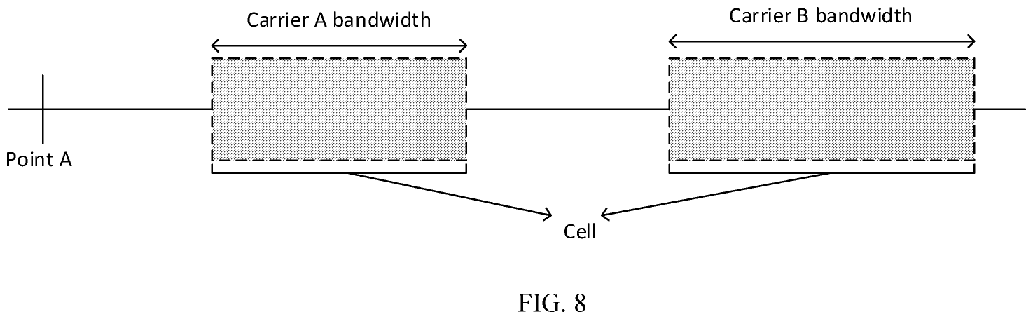

An example is shown in FIG. 8, where two carriers, Carrier A and Carrier B, are configured based on a single frequency reference point (Point A). As shown, each of the two carriers may have a corresponding offset from a common frequency reference point (Point A) and a respective bandwidth.

According to certain aspects, when carriers are combined in a single cell for uplink and downlink, one BWP may be configured with resource blocks (RBs) in multiple carriers. For example, the network entity may transmit to the UE signaling configuring at least one BWP with RBs that span at least two noncontiguous carriers. The BWP may be configured with multiple pairs of starting RB and bandwidth (e.g., jointly encoded in locationAndBandwidth), each associated with a reference subcarrier spacing subcarrierSpacing and a frequency reference point. Each pair of the RB and bandwidth may be corresponding to a contiguous RB segment in a carrier. In some cases, the at least one BWP includes at least one downlink BWP or an uplink BWP.

In some cases, each of the one or more starting RB and BWP bandwidth pairs is associated with a frequency reference point. In some cases, when only on frequency reference point is configured in the single cell, the frequency reference point may not need be expressly indicated in the BWP configuration. In some cases, when multiple frequency reference points are configured in the single cell, but all carriers associated with this BWP are sharing a common frequency reference point, the frequency reference point may only need be indicated once for all the starting RB and BWP bandwidth pairs.

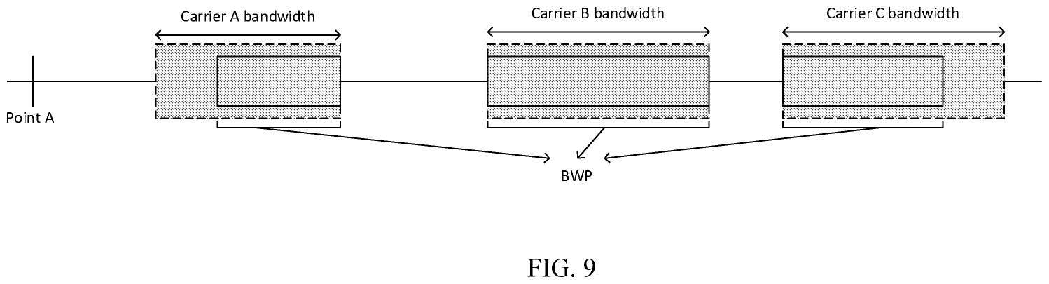

In some cases, one or more starting RB and BWP bandwidth pairs of the at least one BWP are associated with a frequency reference point shared by all noncontiguous carriers spanned by the RBs of the BWP. An example is shown in FIG. 9. As shown, the three noncontiguous carriers A, B, and C may all be associated with the common frequency reference point (Point A). The BWP is configured with multiple pairs of starting RB and bandwidth parameters with respect to Point A.

In some cases, all RBs in all noncontiguous carriers between the lowest frequency and highest frequency subcarriers of the BWP are allocated to the BWP. The one or more pairs include a pair of a starting RB and bandwidth configured for the lowest frequency carrier that contains the BWP. For example, if all RBs in all carriers between the lowest frequency and highest frequency subcarriers of the BWP are allocated to the BWP, only one pair of starting RB for the lowest frequency carrier that contains the BWP and bandwidth needs to be configured.

In some cases, a common reference subcarrier spacing may be configured for all starting RB and bandwidth pairs of the BWP. The subcarrier spacing being the same for the entire BWP may be preferable in some circumstances. In such cases, a single reference subcarrier spacing can be configured for all pairs for the BWP.

In certain aspects, the network entity may consecutively number RBs in the BWP across two or more continuous RB segments in the noncontiguous carriers. For example, when a BWP is configured with RBs in multiple carriers, the RBs configured to the BWP can be consecutively numbered from the lowest frequency to the highest frequency across the carriers. As shown in the example of FIG. 9, the three noncontiguous carriers A, B, and C may include respective BWPs that have RBs consecutively numbered.

In some cases, the network entity may set a frequency domain resource assignment (FDRA) field of a downlink control information (DCI) for scheduling data in the BWP based on the numbering of RBs. For example, scheduling by configuring a common reference subcarrier spacing for RBs in all carriers contained by the BWP may be convenient for the network entity. The RBs that are not allocated to the BWP may be skipped.

In certain aspects, the network entity may schedule multiple BWPs in different noncontiguous carriers in the single cell using a single DCI. For example, the multiple BWPs are non-overlapping in the frequency domain. The multiple BWPs may have different subcarrier spacing. In some cases, the design for the single DCI may be based on one DCI scheduling multiple carriers that compose the cell. For example, instead of using fields for each carrier, the fields may be used for each BWP that is configured within a carrier of the cell. In the current use cases, the DCI differs in that if the DCI is for self-scheduling within the same cell of combined carriers, no carrier indicator field (CIF) would be needed. In some cases, the number of BWPs scheduled by the single DCI may be greater than two.

In certain aspects, the network entity may receive capability information of the UE. The network entity may transmit the single cell multi-carrier configuration to the UE only if the capability information indicates that the UE supports communications on noncontiguous carriers in the cell. For example, reduced capability (RedCap) or enhancement reduced capability (eRedCap) UEs may support a limited bandwidth. Such UEs may afford limited processing efforts. In this case, the UE may not be required to communicate with network or another UE within a frequency bandwidth that contains frequency resources from multiple carriers in the cell with combined carriers. As such, such RedCap or eRedCap UEs may not be expected to simultaneously transmit or receive within RBs in multiple carriers in the cell with combined carriers.

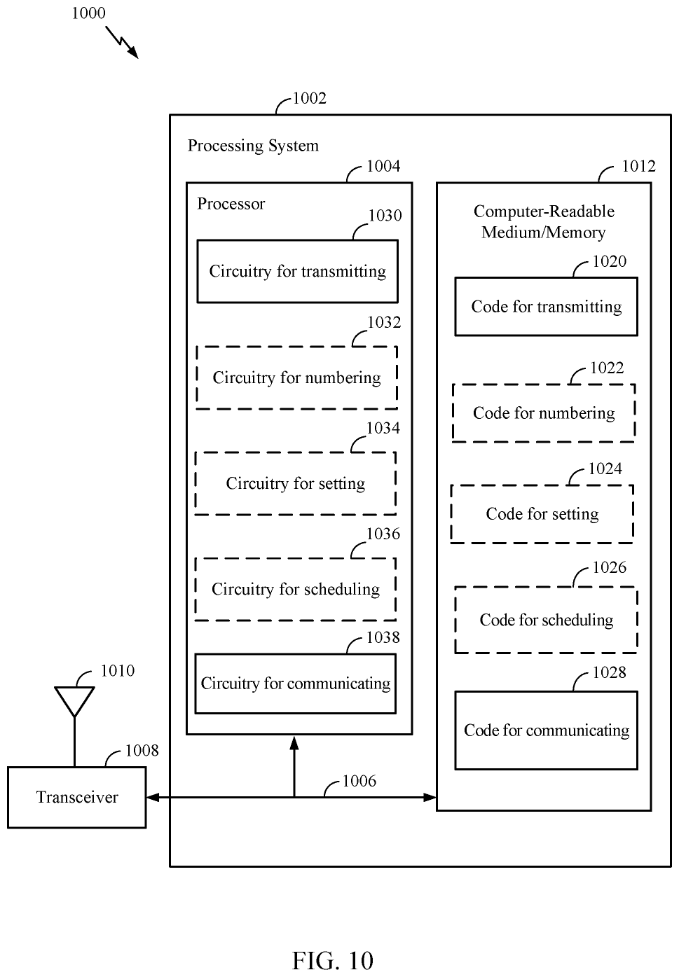

FIG. 10 illustrates a communications device 1000 that may include various components (e.g., corresponding to means-plus-function components) configured to perform operations for the techniques disclosed herein, such as the operations illustrated in FIG. 6. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 6, or other operations for performing the various techniques discussed herein for combining two or more noncontiguous carriers in a single cell. In certain aspects, computer-readable medium/memory 1012 stores code 1020 for transmitting; code 1022 for numbering; code 1024 for setting; code 1026 for scheduling; and/or code 1028 for communicating, in accordance with aspects of the present disclosure. In certain aspects, the processor 1004 has circuitry configured to implement the code stored in the computer-readable medium/memory 1012. The processor 1004 includes circuitry 1030 for transmitting; circuitry 1032 for numbering; circuitry 1034 for setting; circuitry 1036 for scheduling; and/or circuitry 1038 for communicating, in accordance with aspects of the present disclosure.

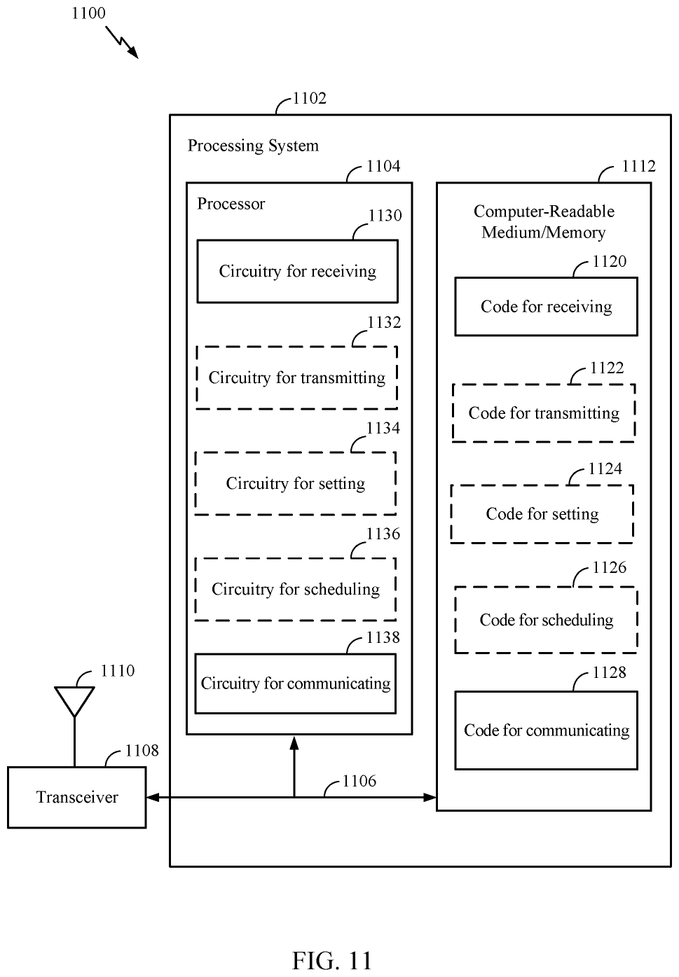

FIG. 11 illustrates a communications device 1100 that may include various components (e.g., corresponding to means-plus-function components) configured to perform operations for the techniques disclosed herein, such as the operations illustrated in FIG. 7. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 7, or other operations for performing the various techniques discussed herein for combining two or more noncontiguous carriers in a single cell. In certain aspects, computer-readable medium/memory 1112 stores code 1120 for receiving; code 1122 for transmitting; code 1124 for setting; code 1126 for scheduling; and/or code 1128 for communicating, in accordance with aspects of the present disclosure. In certain aspects, the processor 1104 has circuitry configured to implement the code stored in the computer-readable medium/memory 1112. The processor 1104 includes circuitry 1130 for receiving; circuitry 1132 for transmitting; circuitry 1134 for setting; circuitry 1136 for scheduling; and/or circuitry 1138 for communicating, in accordance with aspects of the present disclosure.

### Example Aspects

In addition to the various aspects described above, the aspects can be combined. Some specific combinations of aspects are detailed below:

Aspect 1: A method for wireless communications by a network entity, comprising: transmitting, to a user equipment (UE), configuration information configuring the UE for communications on noncontiguous carriers of a single cell; and communicating with the UE on the noncontiguous carriers in accordance with the configuration information.

Aspect 2: The method of Aspect 1, wherein the configuration information indicates: two or more frequency reference points, each to define one of the noncontiguous carriers.

Aspect 3: The method of Aspect 2, wherein: at least a first one of the frequency reference points defines a carrier for uplink transmission; and at least a second one of the frequency reference points defines a carrier for downlink transmission.

Aspect 4: The method of Aspect 2, wherein, for each of the noncontiguous carriers, the configuration information indicates: a frequency offset to a corresponding frequency reference point and a carrier bandwidth.

Aspect 5: The method of Aspect 4, wherein the carrier bandwidth indicated for each noncontiguous carrier is based on an associated reference subcarrier spacing.

Aspect 6: The method of Aspect 1, further comprising: transmitting, to the UE, signaling configuring at least one bandwidth part (BWP) with resource blocks (RBs) that span at least two noncontiguous carriers.

Aspect 7: The method of Aspect 6, wherein the at least one BWP comprises at least one of a downlink BWP or an uplink BWP.

Aspect 8: The method of Aspect 6, wherein the at least one BWP is configured with one or more pairs of starting RBs and BWP bandwidths (“starting RB and BWP bandwidth pairs”), each starting RB and BWP bandwidth pair corresponding to a continuous RB segment in one of the noncontiguous carriers.

Aspect 9: The method of Aspect 8, wherein each of the one or more starting RB and BWP bandwidth pairs is associated with a frequency reference point.

Aspect 10: The method of Aspect 8, wherein the one or more starting RB and BWP bandwidth pairs of the at least one BWP are associated with a frequency reference point shared by all noncontiguous carriers spanned by the RBs of the BWP.

Aspect 11: The method of Aspect 8, wherein: all RBs in all noncontiguous carriers between the lowest frequency and highest frequency subcarriers of the BWP are allocated to the BWP; and the one or more pairs comprises a pair of a starting RB and bandwidth configured for the lowest frequency carrier that contains the BWP.

Aspect 12: The method of Aspect 8, wherein a common reference subcarrier spacing is configured for all starting RB and bandwidth pairs of the BWP.

Aspect 13: The method of Aspect 8, further comprising: consecutively numbering RBs in the BWP across two or more continuous RB segments in the noncontiguous carriers.

Aspect 14: The method of Aspect 13, further comprising: setting a frequency domain resource assignment (FDRA) field of a downlink control information (DCI) for scheduling data in the BWP, based on the numbering of RBs.

Aspect 15: The method of Aspect 6, further comprising: scheduling transmissions in multiple BWPs spanning different noncontiguous carriers with a single downlink control information (DCI).

Aspect 16: The method of Aspect 15, wherein the multiple BWPs are non-overlapping in the frequency domain.

Aspect 17: The method of Aspect 1, further comprising: receiving capability information of the UE; and transmitting the configuration to the UE only if the capability information indicates the UE supports communications on noncontiguous carriers.

Aspect 18: A method for wireless communications by a user equipment (UE), comprising: receiving, from a network entity, configuration information configuring the UE for communications on noncontiguous carriers of a single cell; and communicating with the network entity on the noncontiguous carriers in accordance with the configuration information.

Aspect 19: The method of Aspect 18, wherein the configuration information indicates: two or more frequency reference points, each to define one of the noncontiguous carriers.

Aspect 20: The method of Aspect 19, wherein: at least a first one of the frequency reference points defines a carrier for uplink transmission; and at least a second one of the frequency reference points defines a carrier for downlink transmission.

Aspect 21: The method of Aspect 19, wherein: for each of the noncontiguous carriers, the configuration information indicates: a frequency offset to a corresponding frequency reference point and a carrier bandwidth; or the carrier bandwidth indicated for each noncontiguous carrier is based on an associated reference subcarrier spacing.

Aspect 22: The method of Aspect 18, further comprising: receiving signaling configuring at least one bandwidth part (BWP) with resource blocks (RBs) that span at least two noncontiguous carriers.

Aspect 23: The method of Aspect 22, wherein the at least one BWP comprises at least one of a downlink BWP or an uplink BWP.

Aspect 24: The method of Aspect 22, wherein the at least one BWP is configured with one or more pairs of starting RBs and BWP bandwidths (“starting RB and BWP bandwidth pairs”), each starting RB and BWP bandwidth pair corresponding to a continuous RB segment in one of the noncontiguous carriers.

Aspect 25: The method of Aspect 24, wherein the one or more starting RB and BWP bandwidth pairs of the at least one BWP are associated with a frequency reference point shared by all noncontiguous carriers spanned by the RBs of the BWP.

Aspect 26: The method of Aspect 24, wherein: all RBs in all noncontiguous carriers between the lowest frequency and highest frequency subcarriers of the BWP are allocated to the BWP; and the one or more pairs comprises a pair of a starting RB and bandwidth configured for the lowest frequency carrier that contains the BWP.

Aspect 27: The method of Aspect 24, wherein a common reference subcarrier spacing is configured for all starting RB and bandwidth pairs of the BWP.

Aspect 28: The method of Aspect 18, further comprising: transmitting capability information of the UE; and receiving the configuration from the network entity only if the capability information indicates the UE supports communications on noncontiguous carriers.

Aspect 29: A network entity for wireless communications, comprising: a memory; and a processor coupled to the memory, the processor and the memory configured to: transmit, to a user equipment (UE), configuration information configuring the UE for communications on noncontiguous carriers of a single cell; and communicate with the UE on the noncontiguous carriers in accordance with the configuration information.

Aspect 30: A user equipment (UE) for wireless communications, comprising: a memory; and a processor coupled to the memory, the processor and the memory configured to: receive, from a network entity, configuration information configuring the UE for communications on noncontiguous carriers of a single cell; and communicate with the network entity on the noncontiguous carriers in accordance with the configuration information.

Aspect 31: An apparatus comprising means for performing the method of any of aspects 1 through 28.

Aspect 32: An apparatus comprising at least one processor and a memory coupled to the at least one processor, the memory comprising code executable by the at least one processor to cause the apparatus to perform the method of any of aspects 1 through 28.

Aspect 33: A computer readable medium storing computer executable code thereon for wireless communications that, when executed by at least one processor, cause an apparatus to perform the method of any of aspects 1 through 28.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6 and/or FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a network entity, comprising:
transmitting, to a user equipment (UE), configuration information configuring the UE for communications on noncontiguous carriers of a single cell; and
communicating with the UE on the noncontiguous carriers in accordance with the configuration information.

2. The method of claim 1, wherein the configuration information indicates:
two or more frequency reference points, each to define one of the noncontiguous carriers.

3. The method of claim 2, wherein:
at least a first one of the frequency reference points defines a carrier for uplink transmission; and
at least a second one of the frequency reference points defines a carrier for downlink transmission.

4. The method of claim 2, wherein, for each of the noncontiguous carriers, the configuration information indicates: a frequency offset to a corresponding frequency reference point and a carrier bandwidth.

5. The method of claim 4, wherein the carrier bandwidth indicated for each noncontiguous carrier is based on an associated reference subcarrier spacing.

6. The method of claim 1, further comprising:
transmitting, to the UE, signaling configuring at least one bandwidth part (BWP) with resource blocks (RBs) that span at least two noncontiguous carriers.

7. The method of claim 6, wherein the at least one BWP comprises at least one of a downlink BWP or an uplink BWP.

8. The method of claim 6, wherein the at least one BWP is configured with one or more pairs of starting RBs and BWP bandwidths (“starting RB and BWP bandwidth pairs”), each starting RB and BWP bandwidth pair corresponding to a continuous RB segment in one of the noncontiguous carriers.

9. The method of claim 8, wherein each of the one or more starting RB and BWP bandwidth pairs is associated with a frequency reference point.

10. The method of claim 8, wherein the one or more starting RB and BWP bandwidth pairs of the at least one BWP are associated with a frequency reference point shared by all noncontiguous carriers spanned by the RBs of the BWP.

11. The method of claim 8, wherein:
all RBs in all noncontiguous carriers between the lowest frequency and highest frequency subcarriers of the BWP are allocated to the BWP; and
the one or more pairs comprise a pair of a starting RB and bandwidth configured for the lowest frequency carrier that contains the BWP.

12. The method of claim 8, wherein a common reference subcarrier spacing is configured for all starting RB and bandwidth pairs of the BWP.

13. The method of claim 8, further comprising:
consecutively numbering RBs in the BWP across two or more continuous RB segments in the noncontiguous carriers.

14. The method of claim 13, further comprising:
setting a frequency domain resource assignment (FDRA) field of a downlink control information (DCI) for scheduling data in the BWP, based on the numbering of RBs.

15. The method of claim 6, further comprising:
scheduling transmissions in multiple BWPs spanning different noncontiguous carriers with a single downlink control information (DCI).

16. The method of claim 15, wherein the multiple BWPs are non-overlapping in the frequency domain.

17. The method of claim 1, further comprising:
receiving capability information of the UE; and
transmitting the configuration to the UE only if the capability information indicates the UE supports communications on noncontiguous carriers.

18. A method for wireless communications by a user equipment (UE), comprising:
receiving, from a network entity, configuration information configuring the UE for communications on noncontiguous carriers of a single cell; and
communicating with the network entity on the noncontiguous carriers in accordance with the configuration information.

19. The method of claim 18, wherein the configuration information indicates:
two or more frequency reference points, each to define one of the noncontiguous carriers.

20. The method of claim 19, wherein:
at least a first one of the frequency reference points defines a carrier for uplink transmission; and
at least a second one of the frequency reference points defines a carrier for downlink transmission.

21. The method of claim 19, wherein:
for each of the noncontiguous carriers, the configuration information indicates: a frequency offset to a corresponding frequency reference point and a carrier bandwidth; or
the carrier bandwidth indicated for each noncontiguous carrier is based on an associated reference subcarrier spacing.

22. The method of claim 18, further comprising:
receiving signaling configuring at least one bandwidth part (BWP) with resource blocks (RBs) that span at least two noncontiguous carriers.

23. The method of claim 22, wherein the at least one BWP comprises at least one of a downlink BWP or an uplink BWP.

24. The method of claim 22, wherein the at least one BWP is configured with one or more pairs of starting RBs and BWP bandwidths (“starting RB and BWP bandwidth pairs”), each starting RB and BWP bandwidth pair corresponding to a continuous RB segment in one of the noncontiguous carriers.

25. The method of claim 24, wherein the one or more starting RB and BWP bandwidth pairs of the at least one BWP are associated with a frequency reference point shared by all noncontiguous carriers spanned by the RBs of the BWP.

26. The method of claim 24, wherein:
all RBs in all noncontiguous carriers between the lowest frequency and highest frequency subcarriers of the BWP are allocated to the BWP; and
the one or more pairs comprise a pair of a starting RB and bandwidth configured for the lowest frequency carrier that contains the BWP.

27. The method of claim 24, wherein a common reference subcarrier spacing is configured for all starting RB and bandwidth pairs of the BWP.

28. The method of claim 18, further comprising:
transmitting capability information of the UE; and
receiving the configuration from the network entity only if the capability information indicates the UE supports communications on noncontiguous carriers.

29. A network entity for wireless communications, comprising:
a memory; and
a processor coupled to the memory, the processor and the memory configured to:
transmit, to a user equipment (UE), configuration information configuring the UE for communications on noncontiguous carriers of a single cell; and
communicate with the UE on the noncontiguous carriers in accordance with the configuration information.

30. A user equipment (UE) for wireless communications, comprising:
a memory; and
a processor coupled to the memory, the processor and the memory configured to:
receive, from a network entity, configuration information configuring the UE for communications on noncontiguous carriers of a single cell; and
communicate with the network entity on the noncontiguous carriers in accordance with the configuration information.
